(19) United States
(12) Patent Application Publication
(10) Pub. No.: US 2008/0025346 A1
(43) Pub. Date: Jan. 31, 2008

(54) Method and device for synchronizing and multiplexing asynchronous signals

(75) Inventors: Tsugio Takahashi, Tokyo (JP); Koichi Usami, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/882,002

(22) Filed: Jul. 30, 2007

(30) Foreign Application Priority Data
Jul. 31, 2006 (JP) 2006-207588

(51) Int. Cl. H04J 3/06

(52) U.S. Cl. 370/503

(57) ABSTRACT

A method and an apparatus for synchronizing and multiplexing asynchronous signals are presented that enable the plurality of asynchronous signals to be processed without increasing the scale of circuitry. Clock phase absorption sections allow respective asynchronous STM-N signals to switch to a system clock signal. In accordance with the system clock signal, a MSOH termination section, a pointer reception section and a memory section carry out MSOH termination processing, frame phase absorption processing and the like in serial on the asynchronous STM-N signals. Synchronous signals thus generated after frame phase absorption are multiplexed through processing of changing pointer values and the like by a pointer transmission section.

### BACKGROUND OF THE INVENTION

1. Field of the Invention

This application is based upon and claims the benefit of priority from Japanese Patent Application No. 2006-207588, filed on Jul. 31, 2006, the disclosure of which is incorporated herein in its entirety by reference.

The present invention relates to a technique for multiplexing a plurality of asynchronous signals and, more particularly, to a method and a device for multiplexing asynchronous signals which are received according to a plurality of line clock signals, respectively.

2. Description of the Related Art

In synchronous digital transmission schemes such as SDH (Synchronous Digital Hierarchy) and SONET (Synchronous Optical NETwork), timing clock switching from a plurality of line clock signals for receiving data to an intra-device system clock signal has been performed by a STM frame pointer processing unit (for example, see Japanese Patent Application Unexamined Publication No. 2000-134171). An example of such a SDH multiplexer is shown in FIG. 1A.

FIG. 1A is a block diagram schematically showing the SDH multiplexer. FIG. 1B is a diagram showing a general frame structure of a STM-N signal. Referring to FIG. 1A, when a plurality (M) of STM-N signals are received and subjected to multiplexing processing, the M STM-N signals individually go through the following processing in accordance with respective line clock signals: frame synchronization processing by respective synchronization circuits 1.1 to 1.M; RSOH termination processing by respective RSOH termination sections 2.1 to 2.M; MSOH termination processing by respective MSOH termination sections 3.1 to 3.M; pointer reception processing by respective pointer reception sections 4.1 to 4.M; and clock switching and frame-phase deviation absorption processing by respective memory sections 5.1 to 5.M.

Subsequently, in accordance with a system clock signal, the M STM-N signals after frame-phase deviations have been absorbed are outputted to a pointer transmission section 6 and multiplexed into a single STM-(N×M) signal through processing of changing pointer values and the like. For example, in the case where four STM-1 signals are multiplexed to a single STM-4 signal to be transmitted (that is, M=4 and N=1), section overhead portions of the four STM-1 signals are restructured into a STM-4 frame as shown in FIG. 1B, and payload portions thereof are sequentially multiplexed in units of a byte.

Additionally, the timing switching by using a pointer processing technique requires a memory capacity large enough to absorb all timing deviations, and the problem has already been recognized that the scale of a device grows as the number of processing lines increases. To overcome this problem, a timing switching method without using a pointer processing technique, as well as a SDH transmitter, is disclosed in the Pamphlet of International Publication No. WO00/74283. Specifically, the timings at which multiple lines of main-signal frames are outputted from IF boards corresponding to the respective lines to a common main-signal processing unit, are controlled based on an intra-device reference frame timing.

However, according to the above-mentioned multiplexer and timing switching method, the sequence of processing from the frame synchronization processing by each of the synchronization circuits 1.1 to 1.M up to the clock switching and frame-phase deviation absorption processing by each of the memory sections 5.1 to 5.M is performed in accordance with a corresponding one of the line clock signals, as shown in FIG. 1A. Therefore, the same circuitry (that is, a synchronization circuit, a RSOH termination section, a MSOH termination section, a pointer reception section, and a memory section) needs to be provided for each STM-N signal. Accordingly, the problem still remains that the scale of the entire circuitry grows as the number of lines increases. For example, in the case where asynchronous STM-1 signals are multiplexed into a STM-16 signal, 16 sets of the circuitry from the synchronization circuit up to the memory section are required.

### SUMMARY OF THE INVENTION

An object of the present invention is to provide a method and a device for synchronizing and multiplexing asynchronous signals that enable a plurality of asynchronous signals to be processed without increasing the scale of circuitry.

According to the present invention, a device for synchronizing and multiplexing a plurality of asynchronous signals, includes: a clock switching section for switching a clock signal for each of the plurality of asynchronous signals to an intra-device common clock signal, to generate a plurality of clock-switched asynchronous signals; a synchronization section for synchronizing the plurality of clock-switched asynchronous signals according to the intra-device common clock signal to generate a plurality of synchronized signals; and a multiplexing section for multiplexing the plurality of synchronized signals.

As described above, according to the present invention, the clock switching processing is carried out prior to the synchronization processing, whereby the signal processing after the clock switching processing can be serialized. The plurality of clock-switched asynchronous signals can be processed with a single set of processing circuitry, and the scale of circuitry, as well as power consumption, can be reduced.

### BRIEF DESCRIPTION OF THE DRAWINGS

FIG. 1A is a block diagram schematically showing an existing SDH multiplexer.

FIG. 1B is a diagram showing a general frame structure of a STM-N signal.

FIG. 2 is a block diagram of a line synchronization multiplexer according to a first exemplary embodiment of the present invention.

FIG. 3 is a more detailed block diagram of a serial processing part including a MSOH termination section 11, a pointer reception section 12, and a memory section 13 in the line synchronization multiplexer shown in FIG. 2.

FIG. 4 is a block diagram showing a more detailed configuration of a clock phase absorption section shown in FIG. 2.

FIG. 5A is a timing chart showing an operation of the clock phase absorption section at the time of normal operation.

FIG. 5B is a timing chart showing an operation of the clock phase absorption section when a negative (to-the-minus-side) phase shift request occurs.

FIG. 5C is a timing chart showing an operation of the clock phase absorption section when a positive (to-the-plus-side) phase shift request occurs.

FIG. 6 is a block diagram of a line synchronization multiplexer according to a second exemplary embodiment of the present invention.

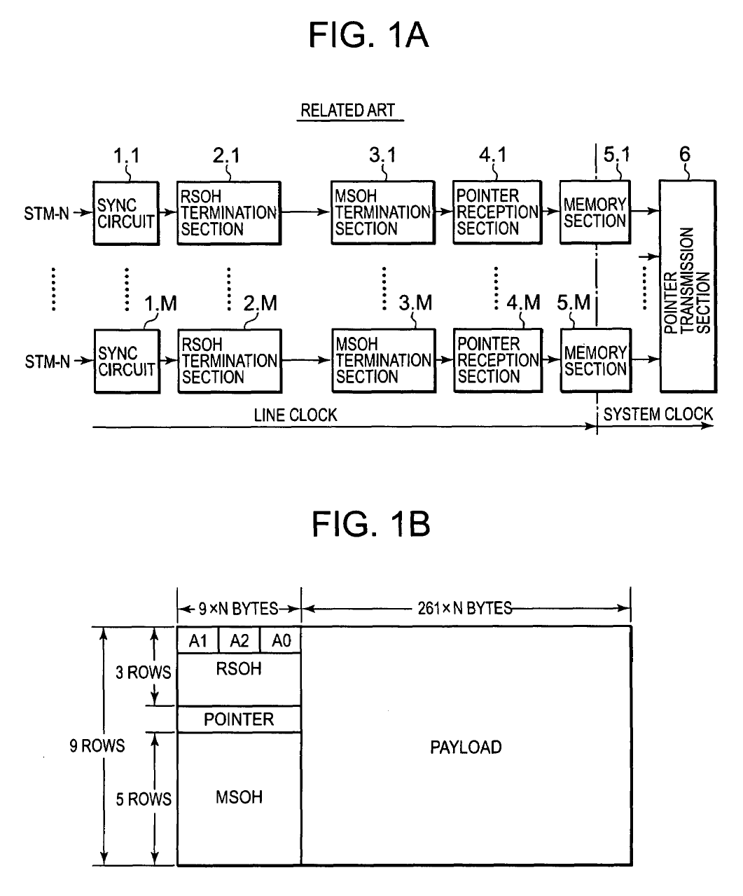

### DETAILED DESCRIPTION OF THE PREFERRED EMBODIMENTS

### 1. First Exemplary Embodiment

### 1.1) Device Configuration

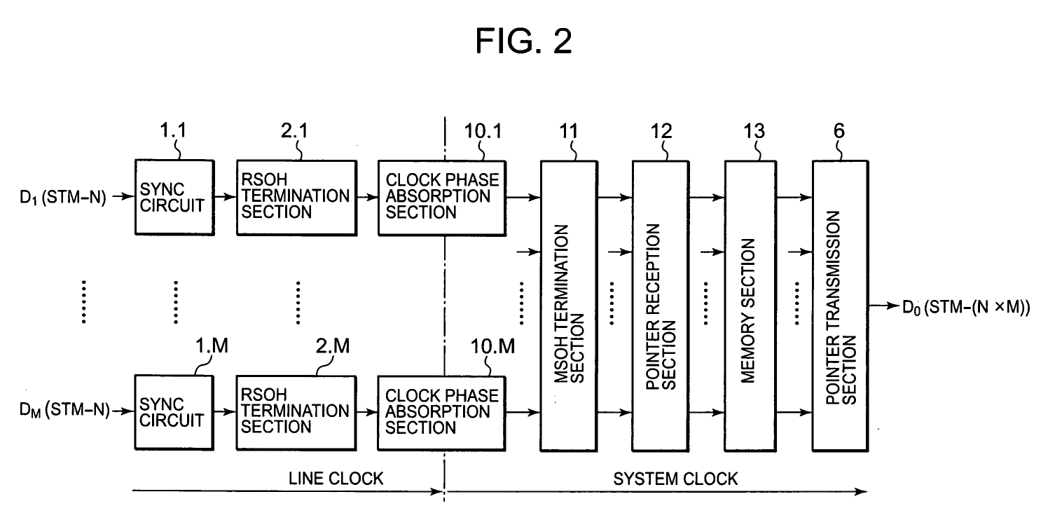

FIG. 2 is a block diagram of a line synchronization multiplexer according to a first exemplary embodiment of the present invention. The line synchronization multiplexer according to the present embodiment is used for, for example, a SDH/SONET transmitter. The line synchronization multiplexer receives a plurality (M) of asynchronous signals D₁ to D_{M} (here, each assumed to be a STM-N signal) and carries out multiplexing processing. Frame synchronization processing by synchronization circuits 1.1 to 1.M and RSOH termination processing by RSOH termination sections 2.1 to 2.M are carried out in accordance with respective line clock signals.

Each of the synchronization circuits 1.1 to 1.M detects a fixed bit pattern (A1 and A2 bytes) from its corresponding asynchronous signal and accomplishes frame synchronization for the asynchronous signal. Subsequently, each of the RSOH termination sections 2.1 to 2.M carries out processing for regenerator section overhead (RSOH) termination on its corresponding asynchronous signal after frame synchronization, and then carries out processing for error monitoring between regenerators, or between a regenerator and a transmission terminal, as well as processing for transfer of monitoring control information.

Subsequently, the clock phase absorption sections 10.1 to 10.M carry out processing for clock switching from the line clock signals to the system clock signal. As described before, the above-mentioned A1 and A2 bytes for frame synchronization are information that is no longer necessary to the circuits at the subsequent stages including the clock phase absorption sections 10.1 to 10.M. Accordingly at the processing stage of the clock phase absorption sections 10.1 to 10.M, these unnecessary information (A1 and A2 bytes) are utilized to accomplish clock phase absorption.

The asynchronous signals D₁ to D_{M} that have switched to the system clock timing are sequentially subjected to serial processing in accordance with the system clock signal, as will be described later. That is, for the plurality of asynchronous signals D₁ to D_{M}, MSOH termination processing by a MSOH termination section 11, pointer reception processing by a pointer reception section 12, and frame phase absorption processing by a memory section 13 can be carried out with a single processing circuit each. Thereafter, a pointer transmission section 6 carries out processing of changing pointer values and the like, whereby a multiplex signal D₀ (STM-(N×M) signal) can be generated.

Incidentally, the clock switching processing by the clock phase absorption sections 10.1 to 10.M, the MSOH termination processing by the MSOH termination section 11, the pointer reception processing by the pointer reception section 12, the frame phase absorption processing by the memory section 13, and the multiplexing processing by the pointer transmission section 6 can also be implemented by executing respective programs on a program-controlled processor.

### 1.2) Serial Processing Part

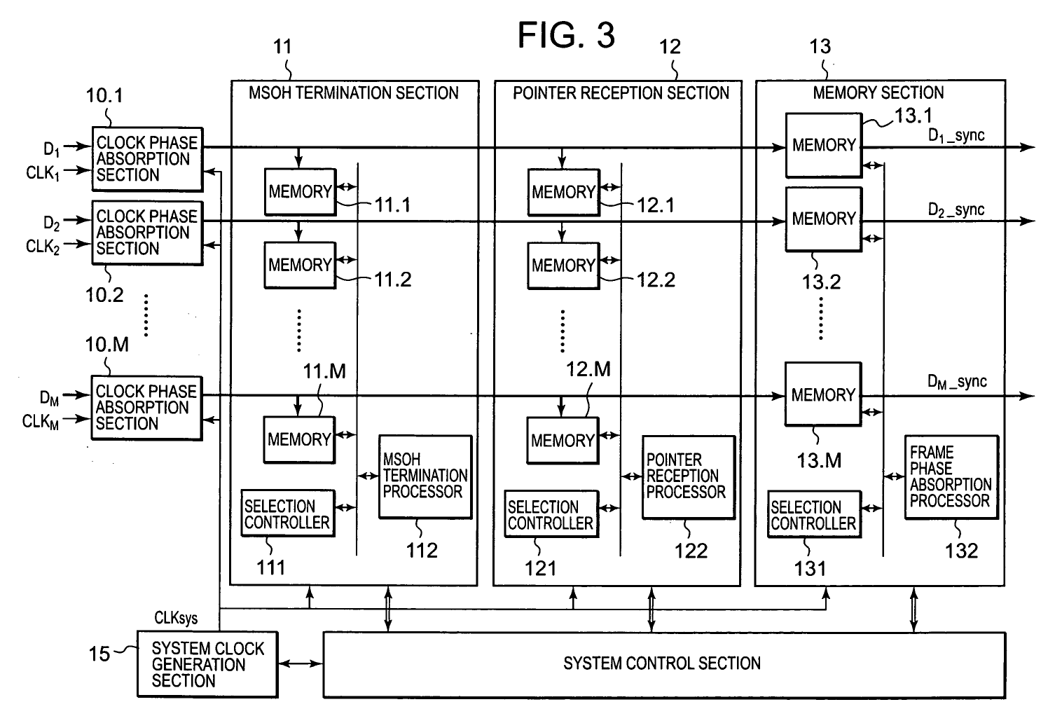

FIG. 3 is a more detailed block diagram of the serial processing part including the MSOH termination section 11, pointer reception section 12, and memory section 13 in the line synchronization multiplexer shown in FIG. 2. The clock phase absorption sections 10.1 to 10.M receive as input the respective line clock signals CLK₁ to CLK_{M} and the system clock signal CLK_{sys}, which is used in common inside the line synchronization multiplexer, and carry out the clock switching processing for the respective asynchronous signals D₁ to D_{M} by utilizing the unnecessary information (here, A1 and A2 bytes). This will be described in more detail later.

A system clock generation section 15 supplies the system clock signal CLK_{sys} to each of the clock phase absorption sections 10.1 to 10.M and also to the MSOH termination section 11, pointer reception section 12, memory section 13, and pointer transmission section 6. A system control section 16 controls the entire operation of the line synchronization multiplexer, including the operations of the clock phase absorption sections 10.1 to 10.M, MSOH termination section 11, pointer reception section 12, memory section 13, and pointer transmission section 6.

The MSOH termination section 11 is provided with memories 11.1 to 11.M corresponding to the clock phase absorption sections 10.1 to 10.M, respectively, and these memories 11.1 to 11.M are bus-connected to a selection controller 111 and a MSOH termination processor 112. The memories 11.1 to 11.M receive as input, at respective timings, the asynchronous signals D₁ to D_{M} from the clock phase absorption sections 10.1 to 10.M, respectively, and store multiplex section overhead (MSOH) portions of the asynchronous signals D₁ to D_{M}, respectively. The stored MSOH portions are transferred to the MSOH termination processor 112 under the control of the selection controller 111, based on the system clock signal CLK_{sys}, and are subjected to well-known MSOH termination processing. Specifically, error monitoring between transmission terminals, system switching in case of failure, transfer of monitoring control information, and the like are carried out.

The pointer reception section 12 is provided with memories 12.1 to 12.M corresponding to the clock phase absorption sections 10.1 to 10.M, respectively, and these memories 12.1 to 12.M are bus-connected to a selection controller 121 and a pointer reception processor 122. The memories 12.1 to 12.M receive as input, at respective timings, the asynchronous signals D₁ to D_{M} from the clock phase absorption sections 10.1 to 10.M, respectively, and store pointer portions of the asynchronous signals D₁ to D_{M}, respectively. The stored pointer portions are transferred to the pointer reception processor 122 under the control of the selection controller 121, based on the system clock signal CLK_{sys}, and are subjected to pointer reception processing based on H1 and H2 bytes.

The memory section 13 is provided with memories 13.1 to 13.M corresponding to the clock phase absorption sections 10.1 to 10.M, respectively, and these memories 13.1 to 13.M are bus-connected to a selection controller 131 and a frame phase absorption processor 132. The memories 13.1 to 13.M receive as input, at respective timings, the asynchronous signals D₁ to D_{M} from the clock phase absorption sections 10.1 to 10.M, respectively, and the respective states of the memories 13.1 to 13.M are sequentially transferred to the frame phase absorption processor 132 under the control of the selection controller 131. Based on these states, the frame phase absorption processor 132 carries out a control of reading a signal from each of the memories 13.1 to 13.M so that all frame phase deviations are absorbed and frame phase synchronization is established.

Synchronous signals D₁_{_{—}}_{sync} to D_{M}_{_{—}}_{sync} thus synchronized in frame phase are sent to the pointer transmission section 6, where pointer processing, such as changing of pointer values after frame phase deviations have been absorbed, is carried out, thereby generating a multiplex signal D₀ (STM-(N×M) signal).

As described above, the MSOH termination section 11, pointer reception section 12, and memory section 13 each perform selective control, whereby the processing of multiplexing a plurality of STM-N signals can be accomplished only with the provision of a single processing circuit for each section (that is, the MSOH termination processor 112, pointer reception processor 122, or frame phase absorption processor 132), irrespective of the number of the plurality of asynchronous signals D₁ to D_{M}. Accordingly, even if the number of the received asynchronous signals D₁ to D_{M} increases, the scale of the entire circuitry hardly grows in comparison with conventional cases. Additionally, power consumption also can be reduced.

### 1.3) Clock Phase Absorption Section

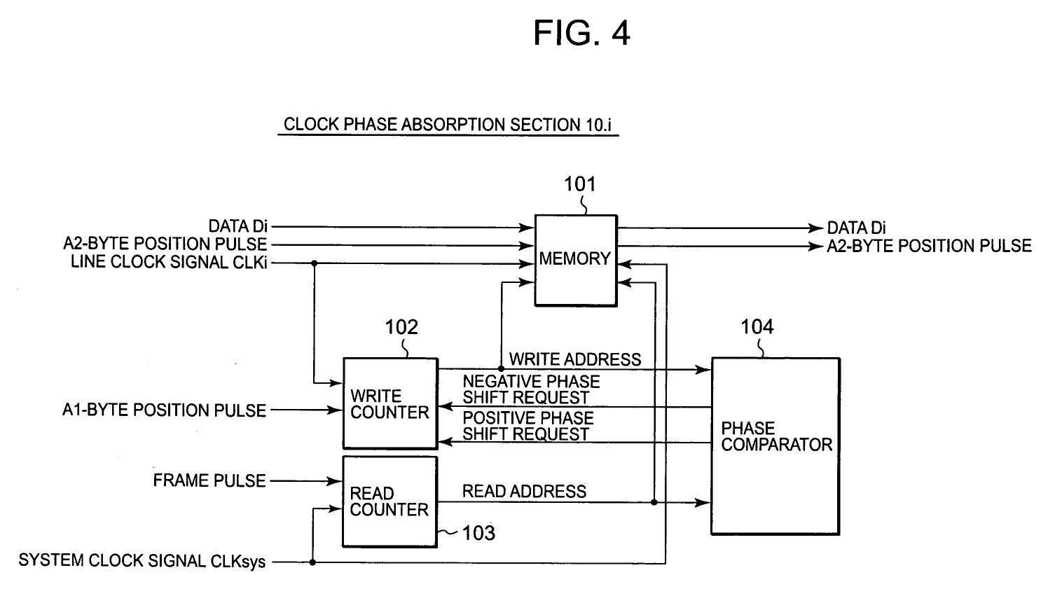

FIG. 4 is a block diagram showing a more detailed configuration of one of the clock phase absorption sections 10.1 to 10.M shown in FIG. 2. Although the clock phase absorption section 10.i corresponding to the i-th (i is any one of the integers ranging from 1 to M) asynchronous signal Dᵢ is illustrated as an example here, the other clock phase absorption sections have the same configurations. Additionally, it is assumed that the A1 and A2 bytes are used as the unnecessary information to be utilized for clock phase absorption.

The clock phase absorption section 10.i is provided with a memory 101 that stores the asynchronous signal Dᵢ, a write counter 102 that supplies a write address for writing the memory 101, a read counter 103 that supplies a read address for reading the memory 101, and a phase comparator 104 that compares and adjusts write and read phases.

The write counter 102 operates in synchronization with its corresponding line clock signal CLKᵢ and generates a write address used to write the memory 101. The read counter 103 operates based on the system clock signal CLK_{sys} and frame pulses of the asynchronous signal Dᵢ and generates a read address used to read the memory 101. In addition, the write and read addresses are also outputted to the phase comparator 104.

The phase comparator 104 compares the phases of the line clock signal CLKᵢ and system clock signal CLK_{sys}, based on the write and read addresses. When the system clock signal CLK_{sys} lags the line clock signal CLKᵢ, the phase comparator 104 outputs a signal of a negative (to-the-minus-side) phase shift request to the write counter 102. When the system clock signal CLK_{sys} leads the line clock signal CLKᵢ, the phase comparator 104 outputs a signal of a positive (to-the-plus-side) phase shift request to the write counter 102. Meanwhile, when the negative phase shift request occurs, the write counter 102 stops adding to the write address at the timing of an A1-byte position pulse of. When the positive phase shift request occurs, the write counter 102 carries out such a control that a value to be added to the write address becomes +2 at the timing of an A1-byte position pulse. Hereinafter, specific examples of the operation of the clock phase absorption section will be described.

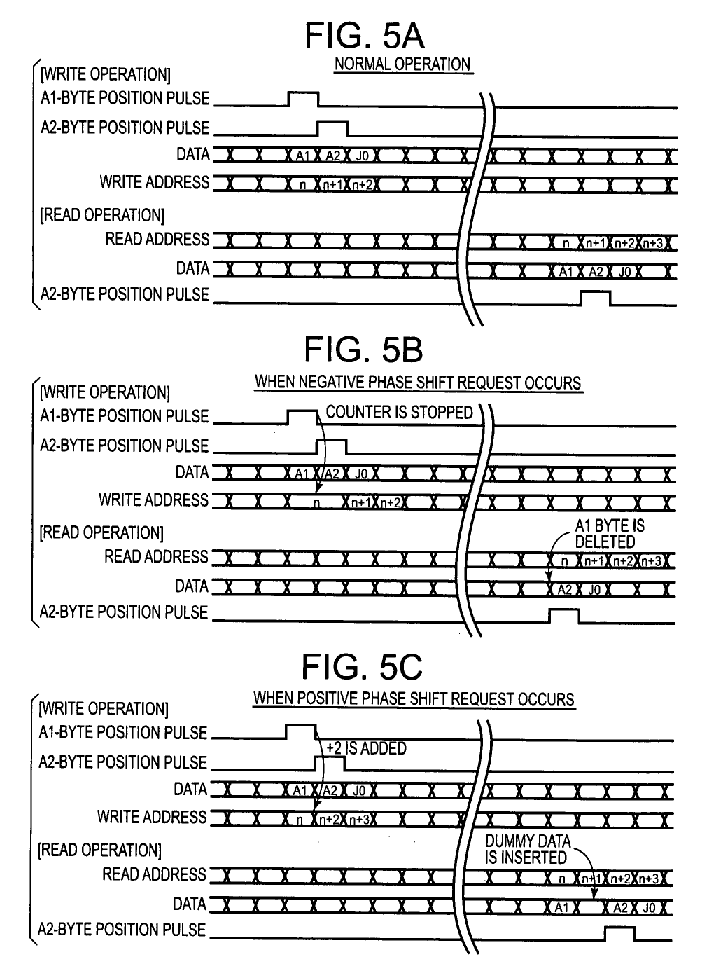

FIG. 5A is a timing chart showing an operation of the clock phase absorption section at the time of normal operation; FIG. 5B is a timing chart showing an operation of the clock phase absorption section when a negative phase shift request occurs; FIG. 5C is a timing chart showing an operation of the clock phase absorption section when a positive phase shift request occurs. Referring to FIG. 5A, when the phases of the line clock signal CLKᵢ and system clock signal CLK_{sys} stay within a normal range, neither write operation nor read operation are changed.

Referring to FIG. 5B, when the system clock signal CLK_{sys} comes to lag the line clock signal CLKᵢ and a signal of a negative phase shift request is inputted to the write counter 102, then the write operation goes as follows. The write counter 102 stops adding at the timing of an A1-byte position pulse; an A1 byte is written at the position of an address n; an A2 byte is written over it thereafter. Accordingly, in the corresponding read operation, the A2 byte is read at the position of the address n, with the A1 byte being deleted.

Referring to FIG. 5C, when the system clock signal CLK_{sys} comes to lead the line clock signal CLKᵢ and a signal of a positive phase shift request is inputted to the write counter 102, then the write operation goes as follows. The write counter 102 adds +2 at the timing of an A1-byte position pulse; an A1 byte is written at the position of an address n; an A2 byte is written at the position of an address (n+2). In the corresponding read operation, the A1 byte is read at the position of the address n; dummy data is read at the position of an address (n+1); the A2 byte is read at the position of the address (n+2). Although the dummy data is inserted between the A1 and A2 bytes as a result, this dummy data is not used at the subsequent stages.

As described above, the A1 byte is deleted when a negative phase shift request occurs, and dummy data is inserted between the A1 and A2 bytes when a positive phase shift request occurs, whereby the clock phase absorption between the line clock signal CLKᵢ and the system clock signal CLK_{sys} is accomplished by increasing or decreasing the data length of one frame.

Note that the clock phase absorption by increasing or decreasing the data length of a frame is not limited to that utilizing the A1 and A2 bytes, but it is possible to utilize any bytes as long as they are unused bytes or no-longer-necessary bytes in the section overhead (SOH). For example, the clock phase absorption between the line clock signal CLKᵢ and the system clock signal CLK_{sys} can also be accomplished by deleting an A2 byte when a negative phase shift request occurs and by inserting dummy data between A2 and J0 bytes when a positive phase shift request occurs.

### 2. Second Exemplary Embodiment

The placement of the clock phase absorption sections is not limited to the placement as in the first exemplary embodiment. As shown below, RSOH termination processing can be implemented with a single processing circuit, by placing a RSOH termination section at a stage subsequent to the clock phase absorption sections.

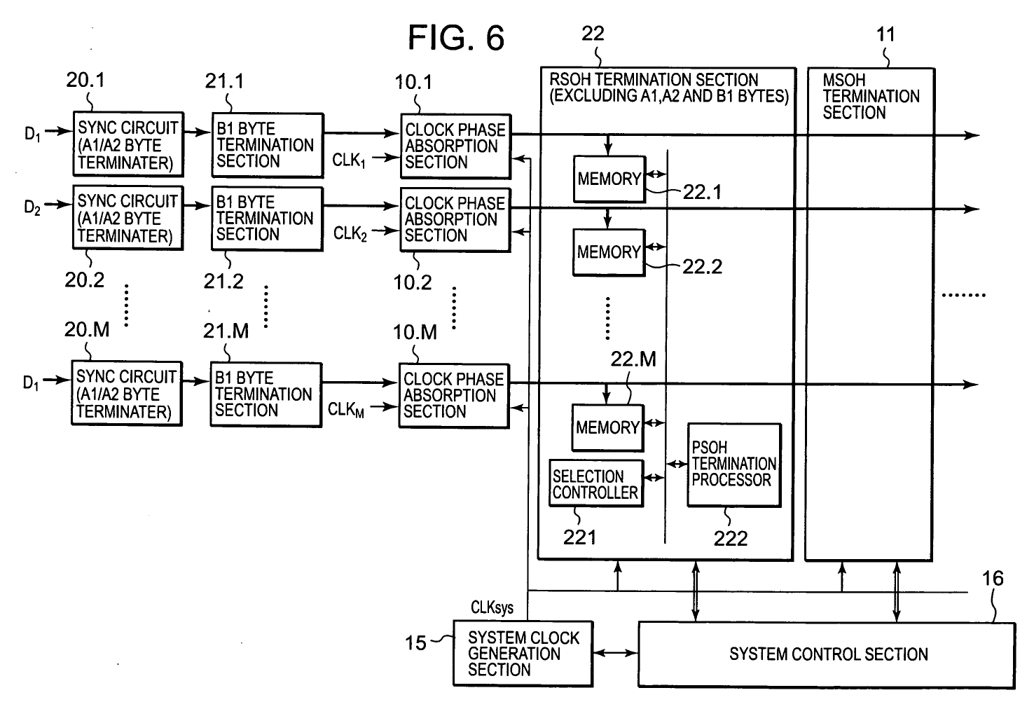

FIG. 6 is a block diagram of a line synchronization multiplexer according to a second exemplary embodiment of the present invention. The line synchronization multiplexer according to the present embodiment is used for, for example, a SDH/SONET transmitter. The line synchronization multiplexer receives a plurality (M) of asynchronous signals D₁ to D_{M} (here, each assumed to be a STM-N signal) and carries out multiplexing processing. Frame synchronization processing by synchronization circuits 20.1 to 20.M and error monitoring processing by B1 byte termination sections 21.1 to 21.M are carried out in accordance with respective line clock signals. Each of the synchronization circuits 20.1 to 20.M terminates A1 and A2 bytes from its corresponding asynchronous signal and accomplishes frame synchronization for the asynchronous signal. Subsequently, each of the B1 byte termination sections 21.1 to 21.M carries out processing for error monitoring between regenerators, or between a regenerator and a transmission terminal, by using a BIP-8 monitoring method.

Subsequently, clock phase absorption sections 10.1 to 10.M carry out processing for clock switching from the line clock signals to a system clock signal. The clock phase absorption sections 10.1 to 10.M can accomplish clock phase absorption by utilizing A1, A2 and/or B1 bytes that are no longer necessary after the processing by the synchronization circuits 20.1 to 20.M and B1 byte termination sections 21.1 to 21.M. The operation of each of the clock phase absorption sections 10.1 to 10.M is already described above.

The asynchronous signals D₁ to D_{M} that have switched to the system clock timing are sequentially subjected to serial processing as will be described below, in accordance with the system clock signal. That is, for the plurality of asynchronous signals D₁ to D_{M}, RSOH termination processing (excluding the A1, A2 and B1 bytes) by a RSOH termination section 22 and MSOH termination processing by a MSOH termination section 11, as well as subsequent pointer reception processing by a pointer reception section 12 and frame phase absorption processing by a memory section 13 as described in the first exemplary embodiment, can be implemented with a single processing circuit each. Thereafter, a pointer transmission section 6 carries out processing of changing pointer values and the like, whereby a multiplex signal D₀ (STM-(N×M) signal) is generated.

The configurations and operations of the MSOH termination section 11, pointer reception section 12, memory section 13, and pointer transmission section 6, as well as the control operation of the system control section 16, are similar to those according to the first exemplary embodiment, and therefore the descriptions thereof will be omitted. Here, the configuration and operation of the RSOH termination section 22 will be described in more detail.

The RSOH termination section 22 is provided with memories 22.1 to 22.M corresponding to the clock phase absorption sections 10.1 to 10.M, respectively, and these memories 22.1 to 22.M are bus-connected to a selection controller 221 and a RSOH termination processor 222. The memories 22.1 to 22.M receive as input, at respective timings, the asynchronous signals D₁ to D_{M} from the clock phase absorption sections 10.1 to 10.M, respectively, and store regenerator section overhead (RSOH) portions of the asynchronous signals D₁ to D_{M}, respectively. The stored RSOH portions are transferred to the RSOH termination processor 222 under the control of the selection controller 221, based on the system clock signal CLK_{sys}, and are subjected to RSOH termination processing excluding the frame synchronization and error monitoring using the A1, A2 and/or B1 bytes.

As described above, the RSOH termination section 22, MSOH termination section 11, pointer reception section 12, and memory section 13 each perform selective control, whereby the processing of multiplexing a plurality of STM-N signals can be accomplished only with the provision of a single processing circuit for each section (that is, the RSOH termination processor 222, MSOH termination processor 112, pointer reception processor 122, or frame phase absorption processor 132), irrespective of the number of the plurality of asynchronous signals D₁ to D_{M}. Accordingly, even if the number of the received asynchronous signals D₁ to D_{M} increases, the scale of the entire circuitry hardly grows in comparison with conventional cases. Additionally, power consumption also can be reduced.

### 3. Third Exemplary Embodiment

As mentioned above, for the clock phase absorption by increasing or decreasing the data length of a frame, any bytes can be utilized as long as they are unused bytes or no-longer-necessary bytes in a section overhead (SOH). Accordingly, it is possible to provide a function of selecting one or more byte to be used for the clock phase absorption. For example, although an increase or a decrease of the data length of a frame is accomplished by using the A1-byte and A2-byte position pulses in the example shown in FIG. 4, the system control section 16 may select bytes to be used for this increase or decrease of the data length of a frame.

### 4. Various Aspects

As described above, according to the present invention, the clock switching processing is carried out at the stage previous to the synchronization processing, whereby the signal processing after the clock switching processing can be serialized. Accordingly, a single processing circuit can perform desired processing of the plurality of asynchronous signals, resulting in reduced amount of processing circuitry.

In the case where the present invention is applied to a SDH/SONET transmission device which receives a plurality of asynchronous STM-N signals according to respective ones of a plurality of line clock signals, a clock switching section switches a line clock signal for each of the asynchronous STM-N signals to an intra-device common clock signal. According to the intra-device common clock signal, the RSOH/MSOH termination processing and frame phase absorption processing for the clock-switched asynchronous STM-N signals can be performed in serial. Such serial processing causes a single processing circuit to perform each processing independently of the number of the asynchronous STM-N signals.

The present invention can be used for the multiplexing of asynchronous signals performed by transmission apparatuses and devices that multiplex asynchronous signals, such as a SDH/SONET transmitter, for example.

The present invention may be embodied in other specific forms without departing from the spirit or essential characteristics thereof. The above-described exemplary embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A device for synchronizing and multiplexing a plurality of asynchronous signals, comprising:
a clock switching section for switching a clock signal for each of the plurality of asynchronous signals to an intra-device common clock signal, to generate a plurality of clock-switched asynchronous signals;
a synchronization section for synchronizing the plurality of clock-switched asynchronous signals according to the intra-device common clock signal to generate a plurality of synchronized signals; and
a multiplexing section for multiplexing the plurality of synchronized signals.

2. The device according to claim 1, wherein the synchronization section comprises:
a plurality of storage sections, each of which stores a corresponding one of the plurality of clock-switched asynchronous signals; and
a phase absorption section for absorbing a phase difference for each of the plurality of clock-switched asynchronous signals which are stored in the plurality of storage sections, respectively.

3. The device according to claim 1, further comprising:
at least one termination section provided between the clock switching section and the synchronization section, wherein each termination section terminates an overhead of each of the plurality of clock-switched asynchronous signals according to the intra-device common clock signal.

4. The device according to claim 3, wherein the termination section comprises:
a plurality of overhead storage sections, each of which stores an overhead of a corresponding one of the plurality of clock-switched asynchronous signals; and
a selector for selecting one of the overheads stored in the plurality of overhead storage sections; and
a termination processing section for terminating a selected overhead.

5. The device according to claim 2, further comprising:
at least one termination section provided between the clock switching section and the synchronization section, wherein each termination section terminates an overhead of each of the plurality of clock-switched asynchronous signals according to the intra-device common clock signal.

6. The device according to claim 5, wherein the termination section comprises:
a plurality of overhead storage sections, each of which stores an overhead of a corresponding one of the plurality of clock-switched asynchronous signals;
a selector for selecting one of the overheads stored in the plurality of overhead storage sections; and
a termination processing section for terminating a selected overhead.

7. A method for synchronizing and multiplexing a plurality of asynchronous signals, comprising:
switching a clock signal for each of the plurality of asynchronous signals to an intra-device common clock signal, to generate a plurality of clock-switched asynchronous signals;
synchronizing the plurality of clock-switched asynchronous signals according to the intra-device common clock signal to generate a plurality of synchronized signals; and
multiplexing the plurality of synchronized signals.

8. The method according to claim 7, the plurality of clock-switched asynchronous signals are synchronized by storing the plurality of clock-switched asynchronous signals in a storage section and absorbing a phase difference for each of the plurality of clock-switched asynchronous signals which are stored in the storage section.

9. The method according to claim 7, wherein an overhead of each of the plurality of clock-switched asynchronous signals is terminated according to the intra-device common clock signal.

10. The method according to claim 9, wherein the termination is performed by:
storing overheads of the plurality of clock-switched asynchronous signals in an overhead storage section;
selecting one of the overheads stored in the overhead storage section; and
terminating a selected overhead.

11. The method according to claim 8, wherein an overhead of each of the plurality of clock-switched asynchronous signals is terminated according to the intra-device common clock signal.

12. The method according to claim 11, wherein the termination is performed by:
storing overheads of the plurality of clock-switched asynchronous signals in an overhead storage section;
selecting one of the overheads stored in the overhead storage section; and
terminating a selected overhead.

13. A program instructing a computer to function as a device for synchronizing and multiplexing a plurality of asynchronous signals, comprising:
switching a clock signal for each of the plurality of asynchronous signals to an intra-device common clock signal, to generate a plurality of clock-switched asynchronous signals;
synchronizing the plurality of clock-switched asynchronous signals according to the intra-device common clock signal to generate a plurality of synchronized signals; and
multiplexing the plurality of synchronized signals.

14. A SDH/SONET transmission device including the device according to claim 1.

15. A SDH/SONET transmission device which executing the method according to claim 7.

16. A SDH/SONET transmission device including a program-controlled processor on which the program according to claim 13 is executed.
